(19) United States
(12) Patent Application Publication
(10) Pub. No.: US 2006/0196333 A1
(43) Pub. Date: Sep. 7, 2006

(54) HAND-HELD APPARATUS WITH THE TOUCH CONTROL DEVICE

(76) Inventors: Chi-Yu Ho, Taipei (TW); Tzu-Che Hsueh, Tainan (TW); Shun-Hsing Lin, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/306,372

(22) Filed: Dec. 26, 2005

Related U.S. Application Data
(62) Division of application No. 10/604,131, filed on Jun. 27, 2003.

(51) Int. Cl. B26D 7/08

(52) U.S. Cl. 83/168

(57) ABSTRACT

A hand-held apparatus with the touch control device is provided. The hand-held apparatus is to place the metal slice on the surface of the hand-held apparatus. When the user touches the metal slice, the backlight or the display in the hand-held apparatus turns on right away, or the hand-held apparatus unlocks the keyboard, and when the user leaves the metal slice (or touches the metal slice again), the backlight or the display in the hand-held apparatus turns off right away, or the hand-held apparatus locks the keyboard. Thus, the present invention has improved facility for the user.

### CROSS-REFERENCE TO RELATED APPLICATION

This is a divisional application of application Ser. No. 10/604,131, filed on Jun. 27, 2003, which is now pending and all disclosures of the application are incorporated herein by reference.

### BACKGROUND OF THE INVENTION

1. Field of Invention

The present invention generally relates to a hand-held apparatus, and more particularly, to a hand-held apparatus with a touch control device.

2. Description of Related Art

Accompanying the great progress in modern communication techniques, the mobile phone has become a commonly used communication tool. In addition, thanks to improvements in manufacturing techniques and cost reduction, the possession of mobile phones is very popular. For the manufacturers of mobile phones, besides focusing on the improvement of the mobile phone's function, how to facilitate the user of the mobile phone is also a major object of mobile phone development.

For the mobile phones on the current market, when the mobile phone is in a state of turning on, in order to have the backlight emitting light, the user has to press a control button in the mobile phone so as to turn on the backlight, and the backlight is turned off automatically after several seconds. Since the control button is quite small, it is inconvenient for the user to use.

### SUMMARY OF THE INVENTION

To solve the problem mentioned above, the present invention provides a hand-held apparatus with a touch control device. The present invention places a metal slice on the surface of the hand-held apparatus. When the user touches the metal slice, the backlight or the display in the hand-held apparatus turns on right away, or the hand-held apparatus unlocks the keyboard, and when the user leaves the metal slice (or touches the metal slice again), the backlight or the display in the hand-held apparatus turns off right away, or the hand-held apparatus locks the keyboard. Thus, the present invention can have improved facility for the user.

In order to achieve the objects mentioned above and others, the present invention provides a hand-held apparatus with a touch control device. The hand-held apparatus comprises a display, a metal slice, and a control circuit wherein the display contains a backlight. The metal slice is located on the surface of the hand-held apparatus, and when the user touches the metal slice, the metal slice will generate an AC signal. The control circuit is coupled to the metal slice and used to convert the AC signal into a DC pulse signal for controlling the hand-held apparatus based on the DC pulse signal.

In a preferred embodiment of the present invention, when the user touches the metal slice, the display is turned on, and when the user touches the metal slice again, the display is turned off.

In the preferred embodiment of the present invention, when the user touches the metal slice, the display is turned on, and when the user touches the metal slice again, the backlight is turned off.

In the preferred embodiment of the present invention, when the user touches the metal slice, the hand-held apparatus unlocks the keyboard, and when the user touches the metal slice again, the hand-held apparatus locks the keyboard.

In the preferred embodiment of the present invention, the control circuit comprises an amplifier, a rectifier, a filter, and a microprocessor. Wherein, the amplifier coupled to the metal slice is used to amplify an AC signal and output the amplified AC signal. The rectifier coupled to the amplifier is used to rectify the amplified AC signal, and also output the rectified signal. The filter coupled to the rectifier is used to filter the rectified signal, and also output a DC pulse signal. The microprocessor coupled to the filter is used to control the hand-held apparatus based on the DC pulse signal.

In the preferred embodiment of the present invention, the hand-held apparatus is a mobile phone, PDA (Personal Digital Assistant), or hand-held computer.

A hand-held apparatus with a touch control device is further provided by the present invention. The hand-held apparatus comprises a display, a first metal slice, a second metal slice, and a control circuit. Wherein, the display contains a backlight. The first metal slice is located on the surface of the hand-held apparatus and is coupled to a positive voltage. The second metal slice is located on the surface of the hand-held apparatus. The control circuit is coupled to the second metal slice, and when both the first metal slice and the second metal slice are touched simultaneously, the control circuit controls the hand-held apparatus depending on the user's touch operation.

In the preferred embodiment of the present invention, when the user touches the first metal slice and the second metal slice simultaneously, the display is turned on, and when the user leaves the first metal slice and the second metal slice, the display is turned off.

In the preferred embodiment of the present invention, when the user touches the first metal slice and the second metal slice simultaneously, the backlight is turned on, and when the user leaves the first metal slice and the second metal slice, the backlight is turned off.

In the preferred embodiment of the present invention, when the user touches the first metal slice and the second metal slice simultaneously, the hand-held apparatus unlocks the keyboard, and when the user leaves the first metal slice and the second metal slice, the hand-held apparatus locks the keyboard.

In the preferred embodiment of the present invention, the control circuit comprises a resistor and a comparator. The resistor has a first electrode and a second electrode, wherein the first electrode of the resistor is coupled to the second metal slice, and the second electrode of the resistor is grounded. The comparator has a first input terminal, a second input terminal, and an output terminal. Wherein, the first input terminal of the comparator is coupled to the second metal slice and the first electrode of the resistor. The second input terminal of the comparator is coupled to a reference voltage. The output terminal of the comparator outputs a level signal for controlling the hand-held apparatus.

In summary, the present invention places a metal slice on the surface of the hand-held apparatus. When the user touches the metal slice, the backlight or the display in the hand-held apparatus turns on right away, or the hand-held apparatus unlocks the keyboard, and when the user leaves the metal slice (or touches the metal slice again), the backlight or the display in the hand-held apparatus turns off right away, or the hand-held apparatus locks the keyboard. Thus, the present invention can have improved facility for the user.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 schematically shows an appearance of a hand-held apparatus with the touch control device of a preferred embodiment according to the present invention;

FIG. 2 schematically shows a circuit block diagram of a hand-held apparatus with the touch control device of a preferred embodiment according to the present invention;

FIG. 3 schematically shows an appearance of a hand-held apparatus with the touch control device of the other preferred embodiment according to the present invention; and

FIG. 4 schematically shows a circuit block diagram of a hand-held apparatus with the touch control device of another preferred embodiment according to the present invention.

### DESCRIPTION OF THE PREFERRED EMBODIMENTS

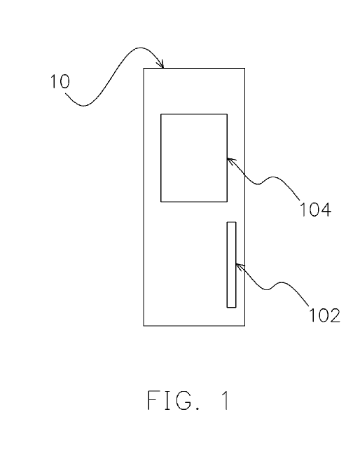

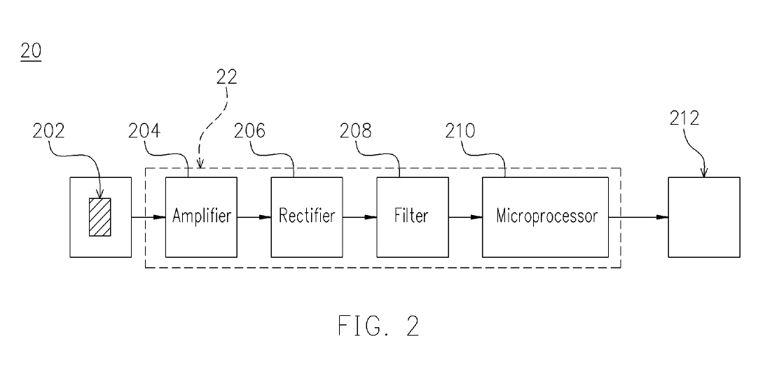

FIG. 1 schematically shows the appearance of a hand-held apparatus with the touch control device of a preferred embodiment according to the present invention. As shown in FIG. 1, the hand-held apparatus 10 (e.g. mobile phone, PDA, or hand-held computer) comprises a metal slice 102 and a display 104, wherein the display 104 contains a backlight (not shown). FIG. 2 schematically shows a circuit block diagram of a hand-held apparatus with the touch control device of a preferred embodiment according to the present invention. As shown in FIG. 2, the hand-held apparatus 20 comprises a metal slice 202, a control circuit 22, and a display 212, wherein the control circuit 22 comprises an amplifier 204, a rectifier 206, a filter 208, and a microprocessor 210. The functions of the hand-held apparatus 10 are described in detail hereinafter.

The metal slice 202 is located on the surface of the hand-held apparatus 20, when the user touches the metal slice 202 with his/her finger, the metal slice 202 will generate an AC signal. Generally speaking, when the metal slice 202 is touched by a user's finger, the metal slice 202 will generate a 60 Hz AC signal. The amplifier 204 coupled to the metal slice 202 is used to amplify the AC signal and output the amplified AC signal. The rectifier 206 coupled to the amplifier 204 is used to rectify the amplified AC signal and output the rectified signal. The filter 208 coupled to the rectifier 206 is used to filter the rectified signal and output a DC pulse signal. The microprocessor 210 coupled to the rectifier 208 is used to control the hand-held apparatus 20 based on the DC pulse signal. When the display 212 is in a turned off state, if the user's finger touches the metal slice 202, the display 212 is turned on, and when the metal slice 202 is touched again, the display 212 is turned off. In addition, when the backlight in the display 212 is in the turned off state, if the user's finger touches the metal slice 202, the backlight is turned on, and when the metal slice 202 is touched again, the backlight is turned off. Moreover, when the keyboard of the hand-held apparatus 20 is locked, if the user's finger touches the metal slice 202, the hand-held apparatus unlocks the keyboard, and when the metal slice 202 is touched again, the hand-held apparatus locks the keyboard.

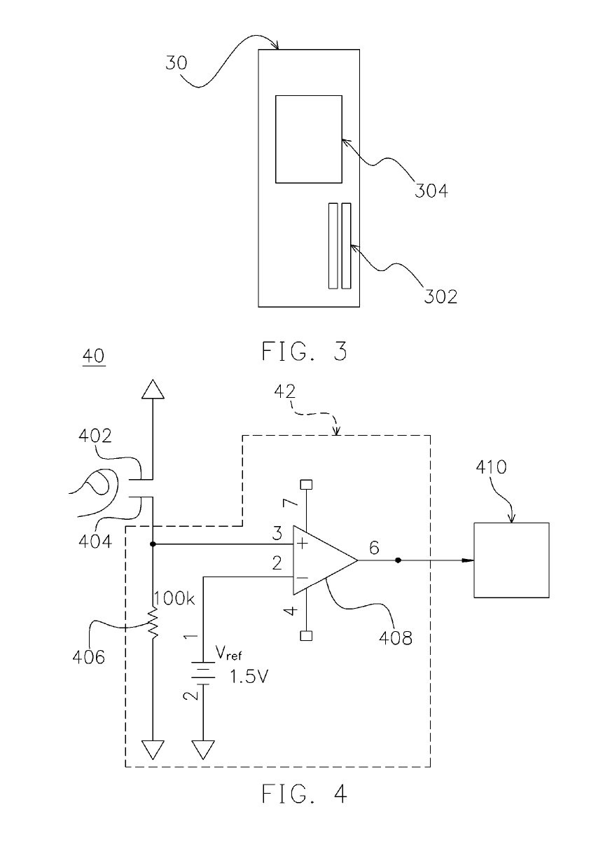

FIG. 3 schematically shows an appearance of a hand-held apparatus with the touch control device of the other preferred embodiment according to the present invention. As shown in FIG. 3, the hand-held apparatus 30 (e.g. mobile phone, PDA, or hand-held computer) comprises two open-circuit metal slices 302 and a display 304, wherein the display 304 contains a backlight (not shown). FIG. 4 schematically shows a circuit block diagram of a hand-held apparatus with the touch control device of another preferred embodiment according to the present invention. As shown in FIG. 4, the hand-held apparatus 40 comprises a metal slice 402, a metal slice 404, a control circuit 42, and a display 410. The control circuit 42 comprises a resistor 406 and a comparator 408. The functions of the hand-held apparatus 40 are described in detail hereinafter.

The metal slice 402 is located on the surface of the hand-held apparatus 40 and coupled to a positive voltage (e.g. 3V). The metal slice 404 is located on the surface of the hand-held apparatus 40. An electrode of the resistor 406 is coupled to the metal slice 404 and a non-inverse input terminal of the comparator 408, and the other electrode of the resistor 406 is grounded. The inverse input terminal of the comparator 408 is coupled to a reference voltage Vref (e.g. 1.5V), and the output terminal of the comparator 408 is coupled to the display 410. In the preferred embodiment, when the user's finger touches both the metal slice 402 and the metal slice 404 simultaneously, the finger equals a resistor of 50KΩ, thus the voltage on the non-inverse input terminal of the comparator 408 is 2V. Since the voltage on the non-inverse input terminal is greater than the voltage on the inverse input terminal (1.5V), the comparator 408 outputs a high level signal so as to turn on the display 410 or the backlight in the display 410, or the hand-held apparatus 40 unlocks the keyboard. When the user's finger leaves the metal slice 402 and the metal slice 404 (i.e. the metal slice 402 and the metal slice 404 are open circuited), the voltage on the non-inverse input terminal of the comparator 408 is 0V, since the voltage on the non-inverse input terminal is less than the voltage on the inverse input terminal (1.5V), the comparator 408 outputs a low level signal so as to turn off the display 410 or the backlight in the display 410, or the hand-held apparatus 40 locks the keyboard.

In summary, the present invention places the metal slice on the surface of the hand-held apparatus. When the user touches the metal slice, the backlight or the display in the hand-held apparatus turns on right away, and when the user leaves the metal slice (or touches the metal slice again), the backlight or the display in the hand-held apparatus turns off right away. Thus, the present invention has improved facility for the user.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A hand-held apparatus with a touch control device, comprising:
a display, comprising a backlight;
a first metal slice, located on the surface of the hand-held apparatus and coupled to a positive voltage;
a second metal slice, located on the surface of the hand-held apparatus; and
a control circuit, coupled to the second metal slice, wherein when a user touches both the first metal slice and the second metal slice simultaneously, the control circuit controls the hand-held apparatus depending on the user's touch operation.

2. The hand-held apparatus with the touch control device of claim 1, wherein when the user touches both the first metal slice and the second metal slice simultaneously, the display is turned on.

3. The hand-held apparatus with the touch control device of claim 2, wherein when the user leaves both the first metal slice and the second metal slice, the display is turned off.

4. The hand-held apparatus with the touch control device of claim 1, wherein when the user touches both the first metal slice and the second metal slice simultaneously, the backlight is turned on.

5. The hand-held apparatus with the touch control device of claim 4, wherein when the user leaves both the first metal slice and the second metal slice, the backlight is turned off.

6. The hand-held apparatus with the touch control device of claim 1, wherein when the user touches both the first metal slice and the second metal slice simultaneously, the hand-held apparatus unlocks a keyboard.

7. The hand-held apparatus with the touch control device of claim 6, wherein when the user leaves both the first metal slice and the second metal slice, the hand-held apparatus locks the keyboard.

8. The hand-held apparatus with the touch control device of claim 1, wherein the control circuit comprises:
a resistor, having a first electrode and a second electrode, wherein the first electrode is coupled to the second metal slice, and the second electrode is grounded; and
a comparator, having a first input terminal, a second input terminal, and an output terminal, wherein the first input terminal is coupled to the second metal slice and the first electrode of the resistor, the second input terminal is coupled to a reference voltage, and the output terminal outputs a level signal so as to control the hand-held apparatus.

9. The hand-held apparatus with the touch control device of claim 1, wherein the hand-held apparatus is a mobile phone.

10. The hand-held apparatus with the touch control device of claim 1, wherein the hand-held apparatus is a PDA (Personal Digital Assistant).

11. The hand-held apparatus with the touch control device of claim 1, wherein the hand-held apparatus is a hand-held computer.
